(19) United States
(12) Patent Application Publication
(10) Pub. No.: US 2015/0292620 A1
(43) Pub. Date: Oct. 15, 2015

(54) PISTON RING WITH VARYING APEX LINES

(71) Applicant: FEDERAL-MOGUL BURSCHEID GMBH, Burscheid (DE)

(72) Inventors: RICHARD MITTLER, BURSCHEID (DE); FRANK NATHEM, MERING (DE)

(21) Appl. No.: 14/441,969

(22) PCT Filed: Sep. 23, 2013
(86) PCT No.: PCT/EP2013/069692

§ 371 Date: May 11, 2015

(30) Foreign Application Priority Data
Nov. 9, 2012 (DE) 10 2012 220 464.4

(51) Int. Cl. F16J 9/20

(52) U.S. Cl. CPC F16J 9/20

(57) ABSTRACT

A piston ring having an outer running face, two flanks and an inner circumferential face is provided. The running face has profiling. The profile of the running face is substantially convexly curved and has an apex. The axial position of the apex varies periodically in the circumferential direction.

The present invention relates to a piston ring for an internal combustion engine or for a compressor, in particular a piston ring having an apex line that is arranged on the running face running in the circumferential direction and varies periodically in the axial direction.

Modern, large-volume engines for ships are still two-stroke diesel engines, since this type of engine can be designed in such a manner that the speed thereof is typically in a range from approximately 50 rpm to 250 rpm (typically less than 100 rpm) and the power thereof can reach up to approximately 100 MW, depending on the number of cylinders. Such large-volume, slow-running two-stroke ship engines preferably act directly on the drive shaft(s) of the propeller(s), since a reduction gear to reduce the rotation speed can be omitted owing to the speed of said engines.

Such large-volume two-stroke engines typically have two separate oil circuits, one for engine lubrication and one for cylinder lubrication. Cylinder lubrication ensures that enough lubricant is provided at a suitable point in time to guarantee sufficient lubrication of the cylinder surfaces and piston rings.

The cylinder lubricant is injected through the liner into the piston chamber, depending on the load of the machine. The piston rings run on this lubricating film, the supporting surface. Here it is a matter inter alia of injecting as little lubricant as possible in order to save costs and prevent over-lubrication. Cylinder lubrication takes place for example in the upper third of the stroke, by supplying lubricant by means of a lubricant pump through lubricant inlets, which are for example provided in a plane in the cylinder wall, into the cylinder so that the lubrication of the piston and of the piston ring is ensured in as optimal a manner as possible. The oil supply into the cylinders usually takes place using the gas counter pressure method.

For example, a lubricant injection system can be used that injects lubricant into the cylinders via nozzles in a precisely metered manner. A computer-controlled system registers the position in which a piston is located and then supplies lubricant in a targeted manner. This takes place at high pressure, so that the lubricant is sprayed very finely in order to obtain the most uniform possible wetting of the cylinder liner, but targeted to where the piston rings are and where the friction actually takes place.

If one considers that modern, large-volume two-stroke ship engines are operated at a speed of approximately 50 rpm to 250 rpm with a stroke of up to 2500 mm, the time span available for the supply of the lubricant and the distribution of the supplied lubricant is short and presents great challenges in ensuring the quality of the lubrication. If one assumes for example that a cylinder has an (inner) diameter of 900 mm and 8 inlets for the oil supply are provided distributed uniformly around the circumference of the cylinder wall, the supplied lubricant must be distributed in the circumferential direction over a length of approx. 350 mm starting from the respective inlets in the time span available.

There are piston rings known e.g. from patent U.S. Pat. No. 3,851,889, with which turbulence is generated in the oil flow by means of a bevel, which is made on one side of the running face of the ring, and grooves or recesses, which are provided therein and lead around the circumference, as a result of which the oil flow in the system is guided mainly in a preferred direction of the piston movement (downwards). Patent document DE 871 390 describes piston rings that are provided with pocket-like depressions in the running face around the circumference, said depressions being intended to facilitate the passage of oil into the interspace between faces sliding on each other.

It has been found that with a conventional design of the one or more piston rings no or only a very low distribution of the lubricant in the circumferential direction (maximum approx. 3%) is obtained, owing to insufficient pressure gradients in the circumferential direction.

Use of the present invention is intended in all internal combustion engines, including those not on ships.

The object of the present invention is to provide a piston ring that ensures low oil consumption and lower blow-by with sufficient lubricating conditions and can be produced inexpensively.

This object is achieved with a piston ring having the features of claim 1. Preferred configurations form the subject matter of the subclaims.

According to the invention, a novel running face profile for a piston ring is proposed. The running face of the piston ring has a substantially convexly curved profile having an apex or pivot point, the axial position of which on the running face varies in relation to the circumferential direction.

A running face of the piston ring shaped in this manner causes hydrodynamic pressures to build up or arise (in particular varying with the axial position of the apex) in the circumferential direction during operation. Said hydrodynamic pressures result in pressure gradients, leading to lubricant flows and a circumferential distribution of the lubricant. The hydrodynamically effected circumferential distribution of the lubricant results in a reduction in the amount needed and a more uniform distribution, in relation to the circumferential direction, of the lubricant supplied or injected into the groove.

A supporting surface of lubricant that is uniform in relation to the circumference is thus obtained as desired in order to ensure sufficient lubricating conditions, to seal off as uniformly as possible from blow-by (or to obtain the lowest possible blow-by), to strip off the lubricant effectively in the working direction of the piston and to allow over-running.

One aspect of the present invention lies in that the oil is transported in the circumferential direction so that less oil is consumed. To this end, the apex is varied or changed constantly over the axial height in the circumferential direction, but preferably no recesses or holes or slots are present on the running face, as is the case in the prior art.

A system consisting of at least two piston rings is also preferably provided. Two of the piston rings are each formed according to the present invention. The courses of the periodically varying axial positions of the apices of the two piston rings according to the invention are phase-offset by 180° in the system arrangement.

The piston ring is preferably formed in such a manner that the variation in the axial position of the apex is periodical in the circumferential direction and preferably the number of periods of the periodically varying axial position is integral.

It is also preferred for the course of the axial position of the apex (B1) in the piston ring to be substantially symmetrical in relation to a plane that is parallel or identical to the centre plane of the piston ring 1.

It is also preferred for the course of the axial position of the apex (B1) in the piston ring to be asymmetrical in relation to a plane that is parallel or identical to the centre plane of the piston ring 1.

Furthermore, the axial position of the apex (B1) in the piston ring preferably has a total variation of approximately 50% to 60% relative to the axial extent of the piston ring.

Furthermore, the number of periods of the course of the axial position of the apex (B1) in the piston ring preferably lies in a range between 4 and 36 inclusive.

Finally, in the system consisting of at least two piston rings, the two piston rings are each preferably a piston ring as stated above and the courses of the periodically varying axial positions of the apices of the at least two piston rings are phase-offset by 180°.

The invention is explained in more detail below using the exemplary embodiments shown in the drawings, in which

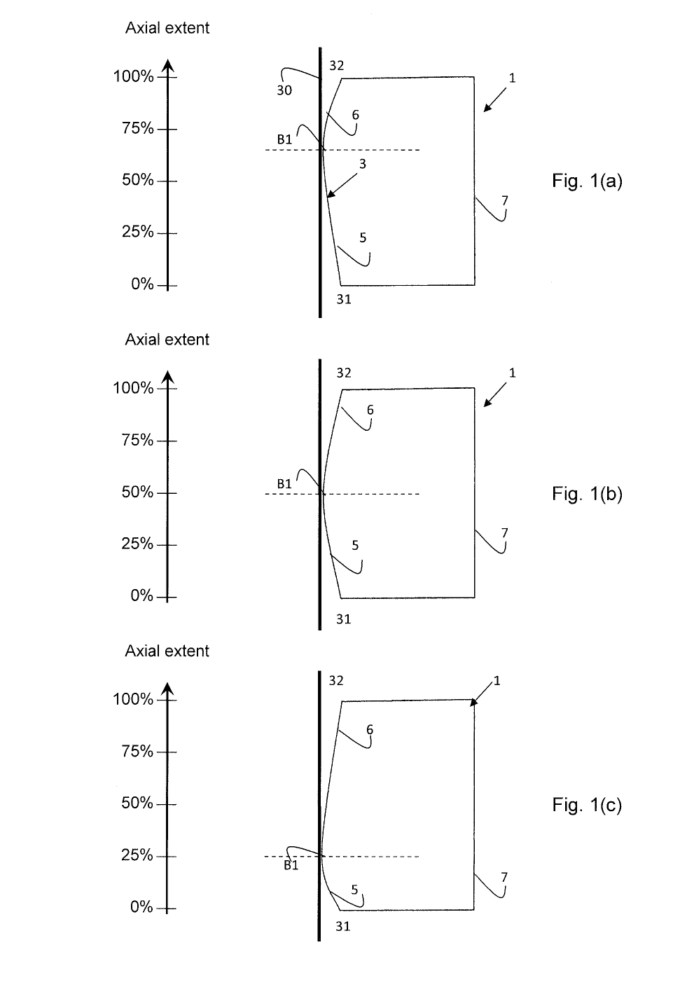

FIGS. 1(a), 1(b), 1(c) show a first (radial) cross section, a second (radial) cross section and a third (radial) cross section through a piston ring according to one embodiment of the present invention, each in different angle positions;

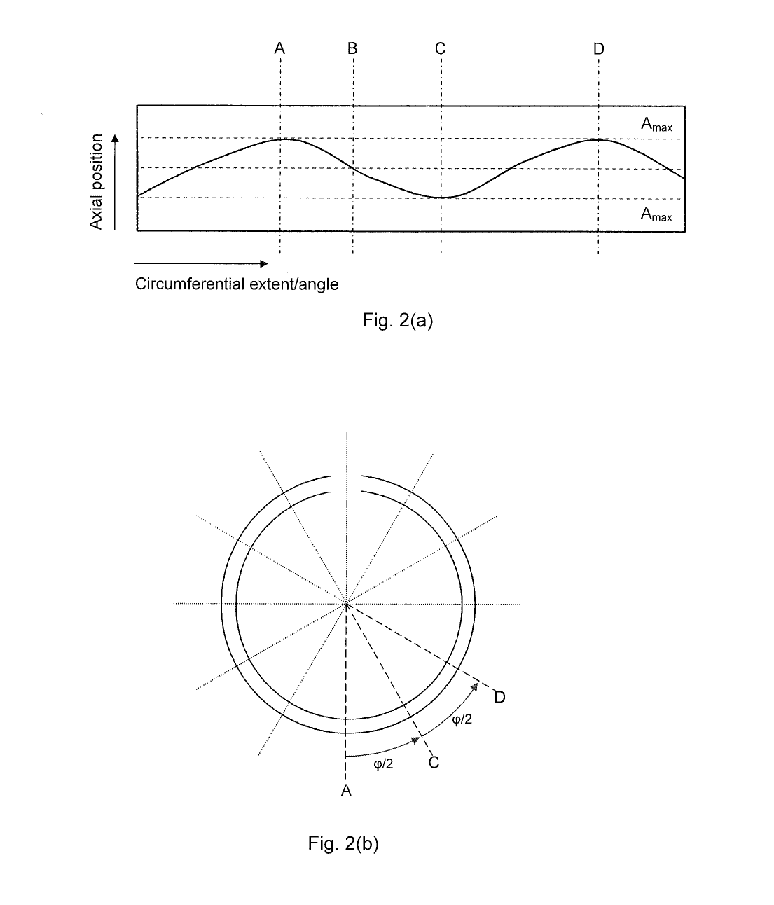

FIG. 2(a) shows a plan view of a detail of the running face, running in the circumferential direction, of the piston ring according to the piston ring according to the invention shown in FIG. 1;

FIG. 2(b) shows a course of the apex line of the profile of the running face according to the detail of the running face, running in the circumferential direction, of the piston ring shown in FIG. 2(a);

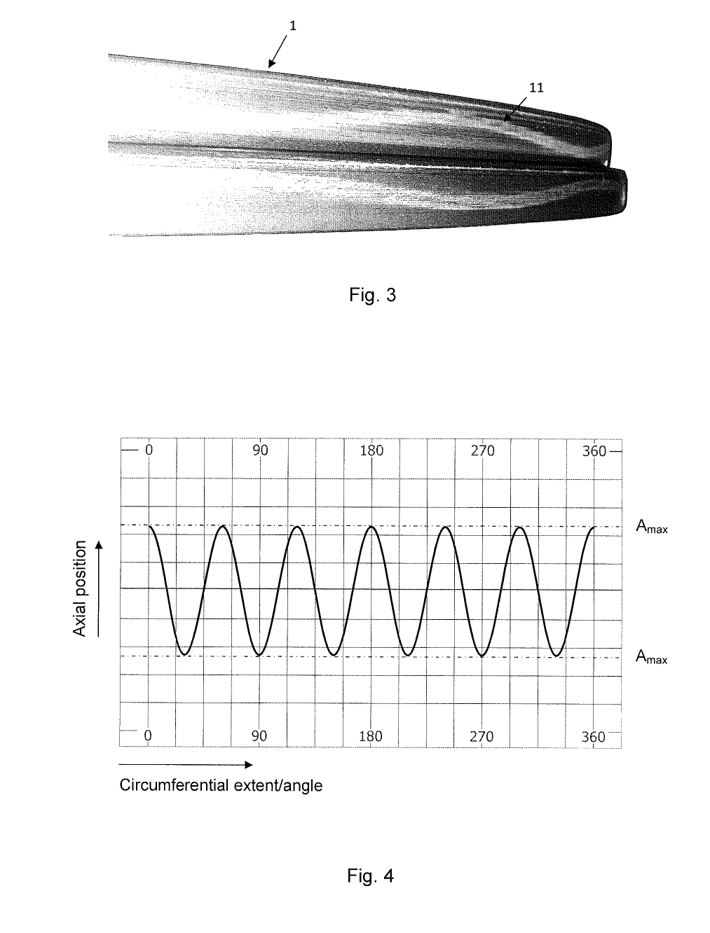

FIG. 3 shows a perspective view of a detail of a piston ring of a further embodiment according to the invention; and

FIG. 4 shows by way of example a functionally described course of the apex line of the profile of the running face according to a further embodiment of the present invention.

FIGS. 1(a) to 1(c) show (radial) cross sections, which are spaced apart from each other in the circumferential direction, through a piston ring 1 according to the invention.

The piston ring 1 according to the invention, which is shown in FIG. 1 and preferably acts as a compression and oil control ring at the same time, has an outer profiled side that faces away from the combustion chamber, i.e. a profiled running face 3 of the piston ring 1, a flank 5 that faces the combustion chamber 31, a flank 6 that faces the oil chamber 32 and an inner circumferential face 7.

It should be noted that, although the description above and below relates to the use of the piston ring 1 according to the invention for a piston in an internal combustion engine, in particular in a two-stroke internal combustion engine, it is immediately clear to a person skilled in the art that a piston ring according to an embodiment according to the invention can also be used in compressors.

The running face 3 has a profile that is substantially convexly curved and has an apex B1 and forms an apex line 11 running along the outer circumference.

In the region of the circumferential apex line 11, the piston ring 1 seals off in relation to a counter running face 30 such as a cylinder liner to prevent blow-by from the combustion chamber 31. The piston movement causes a hydrodynamic oil film to form between the piston ring 1 and the counter running face 30, said oil film forming between the piston ring 1 and the counter running face 30 owing to the piston movement and ensuring sufficient lubrication between said parts. In the cross-sectional views, the apex line 11 running in the circumferential direction is shown as apices B1.

As can already be seen in FIGS. 1(a) to 1(c), the apex B1 of the profile of the running face 3 varies with the position of the cross section in relation to the circumference in the axial direction of the piston ring 1. In FIG. 2(b), a central position of the apex B1 is shown schematically, while FIGS. 2(a) and 2(c) schematically show maximum variation positions of the apex B1 in the two axial directions in relation to the central position.

The centroid of the cross section of the piston ring 1 preferably lies in a plane between the two outermost axial positions of the apex B1. This ensures that the piston ring 1 in the static state bears against the counter running face 30 over the entire course of the apex line 11 and may be minimally spaced apart from said counter running face by a thin oil film (not shown) situated therebetween.

FIG. 2(a) shows a plan view of a detail of the running face 3, running in the circumferential direction, of the piston ring 1 according to the invention. The course of the apex B1 that varies periodically in the axial direction can be seen in FIG. 2(a). The course shown here by way of example is symmetrical to a centre plane of the piston ring 1. I.e. the axial position of the apex B1 varies with a maximal amplitude in relation to the centre plane of the piston ring 1.

It should be noted that the symmetry shown is merely a preferred embodiment of the present invention and does not mean that the invention is limited thereto. For instance, the course of the axial position of the apex B1 can also be symmetrical in relation to a plane that is parallel to and at a distance from the centre plane of the piston ring 1. Furthermore, the course of the axial position of the apex B1 can likewise be asymmetrical, i.e. such that the amplitudes of the course of the axial position of the apex B1 are different in the two opposite axial directions starting from the centre plane of the piston ring 1.

In FIG. 2(a), section positions A, B, C and D are also shown. The cross-sectional view shown in FIG. 1(a) is obtained with a section at position A or D, while the cross-sectional view shown in FIG. 1(b) is obtained with a section at position B and the cross-sectional view shown in FIG. 1(c) is obtained with a section at position C.

FIG. 2(b) shows a view of the plane of the piston ring 1. The circumferential positions and sectional positions A, B, C and D shown in FIG. 2(a) are shown in the piston ring plane. The axial position of the apex B1 varies periodically along the outer circumference of the piston ring 1. FIG. 2(b) shows a periodicity of 6 by way of example. This means that the period angle in relation to the piston ring circumference is φ=60° in the exemplary embodiment shown. The periods of the variations in the axial position of the apex B1 preferably lie in a range from 4 (φ=90°) to 36 (φ=10°) inclusive. The periods are preferably of integral and in particular equal number.

It should be noted that the number of periods can be matched to the number of inlets or nozzles through which the lubricant is pressed or injected into the cylinder, for example using the gas counter pressure method. For example, the number of periods can be equal to the number of inlets or nozzles or else be an integral multiple thereof.

The axial position of the apex B1 preferably has a total variation width (i.e. double the amplitude in the case of a symmetrical course of the axial position) of approximately 50% to 60% relative to the axial extent of the piston ring 1. The axial position of the apex B1 varies preferably within a range of approximately 25% to 75% relative to the axial extent of the piston ring 1.

A further exemplary embodiment according to the invention of the piston ring 1 is shown in perspective view in FIG. 3. As can be seen in FIG. 3, two piston rings according to the invention can be used as a system. In this case, the piston rings are preferably formed in such a manner that the courses of the axial positions of the respective apices are phase-offset from each other by 180°.

The course of the axial position of the apex B1 is preferably constant and can further preferably be described by a periodic, constant function. In particular, the course of the axial position of the apex B1 can be described by a periodic, differentiable function. This means that for example the course of the axial position of the apex B1 can be expressed, for example, as a function of the circumferential angle φ and the number of periods k:

Pₐₓᵢₐₗ=Aₘₐₓ·cos(k·φ)

The above exemplary function is shown for better understanding in FIG. 4.

The piston ring proposed in the present application is in particular for pistons in a system having a diameter of more than 400 mm.

A piston ring formed according to the present invention can preferably be used in a piston ring groove in pistons for internal combustion engines such as large-volume two-stroke internal combustion engines or compressors. It has been found that both oil consumption and blow-by can be greatly reduced compared to known configurations. It should therefore be noted that, with a piston ring according to the invention, a piston ring for pistons of an internal combustion engine or compressor is created in both design and production terms that achieves outstanding results with regard to blow-by and oil consumption while ensuring sufficient lubrication conditions.

The basic concept of the present invention lies in transporting the oil in the circumferential direction in order to reduce oil consumption. This object is achieved in that the pivot point or apex changes over the axial height in the circumferential direction, but no recesses or holes or slots are present on the running face, as in the prior art. The running face remains virtually unchanged, with the exception of the apex. If the piston ring is viewed from the side, a visible profile of a serpentine or sinusoidal line can be seen.

### LIST OF REFERENCE SYMBOLS

1: a piston ring
3: a running face of the piston ring (the outer side that faces away from the combustion chamber) and an outer circumferential face
5: a flank facing the combustion chamber
6: a flank facing the oil chamber
7: an inner circumferential face
10: a convexly curved running face profile
11: an apex line
B1: an apex of the apex line
30: a counter running face e.g. cylinder liner
31: a combustion chamber
32: an oil chamber

1. A piston ring having an outer running face, two flanks and an inner circumferential face, the running face having profiling,
the profile of the running face being substantially convexly curved and having an apex, and
wherein the axial position of the apex varies in the circumferential direction.

2. The piston ring according to claim 1, wherein variation in the axial position of the apex is periodic.

3. The piston ring according to claim 1, wherein the course of the axial position of the apex is substantially symmetrical in relation to a plane that is parallel or identical to the centre plane of the piston ring.

4. The piston ring according to claim 1 wherein the course of the axial position of the apex is asymmetrical in relation to a plane that is parallel or identical to the centre plane of the piston ring.

5. The piston ring according to claim 1, wherein the axial position of the apex has a total variation of approximately 50% to 60% relative to the axial extent of the piston ring.

6. The piston ring according claim 1, wherein the number of periods of the course of the axial position of the apex lies in a range between 4 and 36 inclusive.

7. A system consisting of at least two piston rings, wherein two of the piston rings are each a piston ring according to claim 1, and the courses of the periodically varying axial positions of the apices of the at least two piston rings are phase-offset by 180°.

8. The piston ring according to claim 2, wherein the number of periods of the periodically varying axial position is integral.
